(19) United States
(12) Patent Application Publication
(10) Pub. No.: US 2021/0391657 A1
(43) Pub. Date: Dec. 16, 2021

(54) ANTENNA, MULTI-BAND ANTENNA AND ANTENNA TUNING METHOD

(71) Applicant: CommScope Technologies LLC, Hickory, NC (US)

(72) Inventors: Changfu Chen, Suzhou (CN); Haiyan Chen, Suzhou (CN); Pengfei Guo, Suzhou (CN); Runmiao Wu, Runmiao (CN)

(21) Appl. No.: 17/316,825

(22) Filed: May 11, 2021

(30) Foreign Application Priority Data
Jun. 1, 2020 (CN) 2020104827150
Apr. 14, 2021 (CN) 202110399350X

(51) Int. Cl. H01Q 25/00; H01Q 9/04; H01Q 21/06

(52) U.S. Cl. CPC H01Q 25/001; H01Q 21/065; H01Q 9/045

(57) ABSTRACT

An antenna includes a reflector having a front side that includes a first region and a second region that does not overlap the first region, a first column of radiating elements element that is located on the front side of the reflector and is configured to emit electromagnetic radiation within a first frequency band, the first column of radiating elements mounted to extend forwardly from the first region, and a reflection reducing component mounted forwardly of the second region, wherein the reflection reducing component is configured such that electromagnetic radiation within the first frequency band that is reflected by the reflection reducing component is weaker than electromagnetic radiation within the first frequency band that is reflected by the first region of the reflector.

### CROSS-REFERENCE TO RELATED APPLICATION

The present application claims priority to Chinese Patent Application No. 202010482715.0, filed Jun. 1, 2020 and Chinese Patent Application No. 202110399350.X, filed Apr. 14, 2021, the entire content of each of which is incorporated herein by reference as if set forth fully herein.

### FIELD

The present invention relates to communication systems, and more specifically, to an antenna, a multiband antenna and an antenna tunning method.

### BACKGROUND

A beamforming antenna is generally implemented as a phased array of radiating elements. The sizes of the radiating elements and the distances between adjacent radiating elements are generally proportional to the operating frequencies of signals that are transmitted and received by the radiating elements. A higher operating frequency corresponds to a smaller radiating element and a smaller spacing between adjacent radiating elements. A multi-band antenna may include multiple arrays of radiating elements, and radiating elements of different arrays may have different operating frequency bands.

FIGS. 1A and 1B are schematic diagrams of a conventional multi-band antenna assembly 100. The multi-band antenna assembly 100 includes a reflector 160. The reflector 160 may comprise a metal surface that acts as a ground plane and reflects the electromagnetic radiation that reaches the reflector may be redirected to propagate forwardly, for example. The antenna assembly 100 may further include additional mechanical and electronic components disposed on a rear side of the reflector 160, such as one or more of a connector, a cable, a phase shifter, a remote electronic inclination (RET) unit, a duplexer, etc. An antenna including the antenna assembly 100 may be mounted on a raised structure for operation, such as an antenna tower, a telephone pole, a building, a water tower, etc., such that the reflector 160 of the antenna extends substantially perpendicular to the ground. The antenna usually further includes a radome (not shown) for environmental protection.

The antenna assembly 100 further includes an array of radiating elements 110, an array of radiating elements 120, and an array of radiating elements 130 that are arranged on a front side of the reflector 160. In some embodiments, some or all of the radiating elements may be dual-polarized radiating elements that are configured to radiate at two different polarizations. In the illustrated embodiment, an operating frequency band of the radiating elements 110 may be, for example, 3.1 to 4.2 GHz or a sub-band thereof. An operating frequency band of the radiating elements 120 may be, for example, 1695 to 2690 MHz or a sub-band thereof. An operating frequency band of the radiating elements 130 may be, for example, 694 to 960 MHz or a sub-band thereof. Each radiating element 120 includes a respective director 121 that tunes the radiation pattern of the array of radiating element 120 and/or improves the return loss of the radiating elements 120. The array of radiating elements 120 includes two vertically-extending linear arrays that are adjacent one another in the horizontal direction. Depending on how these radiating elements 120 are fed, the two linear arrays may be configured to form two separate antenna beams (at each polarization), or may be configured to form a single antenna beam (at each polarization). The arrays of radiating elements 110 and 130 extend vertically and are arranged between the two linear arrays of radiating elements 120, respectively. The radiating elements 130 are staggered horizontally to have a slight offset to either side of the vertical center axis of the array of radiating elements 130, so as to obtain a narrower antenna beam in the azimuth plane.

### SUMMARY

One of the aims of the present invention is to provide an antenna, a multi-band antenna, and a method for installing an antenna, and a method for tunning an antenna.

A first aspect of this invention is to provide an antenna, which comprises: a reflector comprising a front side that includes a first region and a second region that does not overlap the first region; a first column of radiating elements comprising at least one first radiating element that is located on the front side of the reflector and is configured to emit electromagnetic radiation within a first frequency band, the first column of radiating elements mounted to extend forwardly from the first region; and a reflection reducing component mounted forwardly of the second region, wherein the reflection reducing component is configured such that electromagnetic radiation within the first frequency band that is reflected by the reflection reducing component is weaker than electromagnetic radiation within the first frequency band that is reflected by the first region of the reflector.

A second aspect of this invention is to provide a multi-band antenna, which comprises: a reflector; a first radiating element array configured to emit electromagnetic radiation within a first frequency band; a second radiating element array configured to emit electromagnetic radiation within a second frequency band; and a reflection reducing component covering a first portion of a front surface of the reflector, the reflection reducing component is configured to reduce a reflection by the first portion to the electromagnetic radiation within the first frequency band and substantially not to reduce a reflection by the first portion to the electromagnetic radiation within the second frequency band, wherein in a front view of the antenna, a first region where the first radiating element array extends is adjacent a second region where the second radiating element array extends, and a third region where the reflection reducing component extends overlaps the second region and does not overlap the first region.

A third aspect of this invention is to provide a multi-band antenna, which comprises: a reflector; a first radiating element array configured to emit electromagnetic radiation within a first frequency band; a second radiating element array configured to emit electromagnetic radiation within a second frequency band; and a reflection reducing component being located on a front surface of the reflector and covering a first portion of the reflector, the reflection reducing component is configured to weaken the electromagnetic radiation within the first frequency band that is reflected by the first portion and substantially not to weaken the electromagnetic radiation within the second frequency band that is reflected by the first portion, wherein in a front view of the antenna, a first region where the first radiating element array extends overlaps with a second region where the second radiating element array extends, and a third region where the reflection reducing component extends overlaps with the second region and does not overlap with the first region.

A fourth aspect of this invention is to provide a method for installing an antenna configured to generate an antenna beam that is formed by electromagnetic radiation within a first frequency band, the method comprising: installing a reflection reducing component on a mounting surface for the antenna and on a side of the antenna, wherein the mounting surface is able to reflect the electromagnetic radiation within the first frequency band, and the reflection reducing component is configured to reduce a reflection by the mounting surface to the electromagnetic radiation within the first frequency band.

A fifth aspect of this invention is to provide a multi-band antenna, which comprises: a reflector; an array of first radiating elements that are configured to emit electromagnetic radiation within a first frequency band; an array of second radiating elements that are configured to emit electromagnetic radiation within a second frequency band that is different from the first frequency band; and a reflection reducing component positioned forwardly of the reflector that is configured to reduce reflections of incident electromagnetic radiation that is within the first frequency band more than electromagnetic radiation that is within the second frequency band.

A sixth aspect of this invention is to provide a multi-band antenna, including: a reflector; an array of first radiating elements mounted to extend forwardly from the reflector and configured to emit electromagnetic radiation within a first frequency band; an array of second radiating elements mounted to extend forwardly from the reflector and configured to emit electromagnetic radiation within a second frequency band different from the first frequency band; and a reflection-reducing component, which is positioned in front of the reflector, wherein the reflection-reducing component includes a dielectric layer and a metallic pattern arranged on the first major surface of the dielectric layer; the metallic pattern includes periodically arranged pattern elements, wherein each pattern element includes a plurality of metallic sub-regions that are structurally separated from one another via slits; and the reflection-reducing component is configured to reduce the reflection of the incident electromagnetic radiation within the first frequency band more than the reflection of the incident electromagnetic radiation within the second frequency band at a predetermined incident angle.

A seventh aspect of this invention is to provide an antenna, including: a reflector; an array of first radiating elements configured to emit electromagnetic radiation within the first frequency band, including: a reflection-reducing component, which is positioned in front of the reflector, wherein the reflection-reducing component includes a dielectric layer, a metallic pattern arranged on the first major surface of the dielectric layer; the metallic pattern comprises a plurality of pattern elements, wherein each pattern element includes a plurality of metallic sub-regions that are structurally separated from one another via slits, so that the absorptance of the reflection-reducing component for electromagnetic radiation incident within the first frequency band at a predetermined incident angle exceeds 80% when the thickness of its dielectric layer is between 1 mm and 10 mm.

An eighth aspect of this invention is to provide an antenna tunning method, wherein the antenna comprises a reflector and an array of first radiating elements mounted on the reflector, the first radiating elements are configured to emit electromagnetic radiation within the first frequency band, and the method includes: positioning the reflection-reducing component in front of the reflector to at least partially absorb the incident electromagnetic radiation within the first frequency band, wherein the reflection-reducing component includes a dielectric layer and a metallic pattern arranged on the first major surface of the dielectric layer; the metallic pattern includes a plurality of pattern elements, wherein each pattern element includes a plurality of metallic sub-regions that are structurally separated from one another via slits.

### BRIEF DESCRIPTION OF THE DRAWING

FIG. 1A is a front view of a prior art multi-band antenna assembly.

FIG. 1B is a bottom view of the multi-band antenna assembly of FIG. 1A in which directors for radiating elements are removed.

FIG. 2A is a bottom view of an antenna model configured to measure a radiation pattern in a simulation experiment.

FIG. 2B is a graph of the simulated radiation pattern for the antenna model of FIG. 2A as a function of azimuth angle.

FIG. 2C is a bottom view of an antenna model configured to measure a radiation pattern in another simulation experiment.

FIG. 2D is a graph of the simulated radiation pattern for the antenna model of FIG. 2C as a function of azimuth angle.

FIG. 2E is a bottom view of an antenna model configured to measure a radiation pattern in yet another simulation experiment.

FIG. 2F is a graph of the simulated radiation pattern for the antenna model of FIG. 2E as a function of azimuth angle.

FIG. 3A is a schematic diagram illustrating how electromagnetic radiation generated by the antenna model of FIG. 2A is reflected by a radome.’

FIG. 3B is a schematic diagram illustrating how electromagnetic radiation generated by the antenna model of FIG. 2E is reflected by the radome.

FIG. 3C is a schematic diagram illustrating how electromagnetic radiation generated by an antenna according to an embodiment of the present invention is reflected by a radome.

FIG. 4 is a front view of a multi-band antenna assembly according to an embodiment of the present invention.

FIG. 5A to FIG. 5E are simplified front views of multi-band antenna assemblies according to further embodiments of the present invention.

FIG. 6A is a perspective view of at least a part of a reflection reducing component in an antenna according to an embodiment of the present invention.

FIG. 6B is a simplified side view of the reflection reducing component of FIG. 6A.

FIG. 6C is a front view of at least a part of a reflection reducing component in an antenna according to a further embodiment of the present invention.

FIG. 6D is a simplified side view of the reflection reducing component of FIG. 6C.

FIG. 7A is a perspective view of at least a part of a reflection-reducing component in the antenna according to yet another embodiment of the present disclosure.

FIG. 7B is a schematic perspective view of the unit structure of the reflection-reducing component of FIG. 7A.

FIG. 7C is an exemplary absorptance graph of the reflection-reducing component of FIG. 7A at a predetermined incident angle.

FIGS. 8A-8F are example variants of the pattern element in the unit structure of the reflection-reducing component of FIG. 7A.

FIG. 9 is a simplified front view of at least a part of a reflection reducing component in an antenna according to a further embodiment of the present invention.

FIG. 10A to FIG. 10C are graphs of the simulated radiation patterns for antennas including radomes at frequencies of 3.1 GHz, 3.6 GHz and 4 GHz as a function of azimuth angle, where curves C1, C3 or C5 are radiation patterns generated by an array of radiating elements in the antenna including the multi-band antenna assembly shown in FIG. 1A, and curves C2, C4 or C6 are radiation patterns generated by an array of radiating elements in the antenna including the multi-band antenna assembly shown in FIG. 4.

FIG. 11A is a graph of the simulated radiation patterns for antennas including radomes at a frequency of 806 MHz as a function of azimuth angle, where curve C7 is the radiation pattern generated by an array of radiating elements in the antenna including the multi-band antenna assembly shown in FIG. 1A, and curve C8 is the radiation pattern generated by the array of radiating elements in the antenna including the multi-band antenna assembly shown in FIG. 4.

FIG. 11B is a graph of the simulated radiation patterns for antennas including radomes at a frequency of 1.695 GHz as a function of azimuth angle, where curve C9 is the radiation pattern generated by an array of radiating elements in the antenna including the multi-band antenna assembly shown in FIG. 1A, and curve C10 is the radiation pattern generated by an array of radiating elements in the antenna including the multi-band antenna assembly shown in FIG. 4.

Note that, in some cases the same elements or elements having similar functions are denoted by the same reference numerals in different drawings, and description of such elements is not repeated. In some cases, similar reference numerals and letters are used to refer to similar elements, and thus once an element is defined in one figure, it need not be further discussed in subsequent figures.

In order to facilitate understanding, the position, size, range, or the like of each structure illustrated in the drawings may not be drawn to scale. Thus, the invention is not necessarily limited to the position, size, range, or the like as disclosed in the drawings.

### DETAILED DESCRIPTION

The present invention will be described with reference to the accompanying drawings, which show a number of example embodiments thereof. It should be understood, however, that the present invention can be embodied in many different ways, and is not limited to the embodiments described below. Rather, the embodiments described below are intended to make the invention of the present invention more complete and fully convey the scope of the present invention to those skilled in the art. It should also be understood that the embodiments disclosed herein can be combined in any way to provide many additional embodiments.

The terminology used herein is for the purpose of describing particular embodiments, but is not intended to limit the scope of the present invention. All terms (including technical terms and scientific terms) used herein have meanings commonly understood by those skilled in the art unless otherwise defined. For the sake of brevity and/or clarity, well-known functions or structures may be not described in detail.

Herein, when an element is described as located “on” “attached” to, “connected” to, “coupled” to or “in contact with” another element, etc., the element can be directly located on, attached to, connected to, coupled to or in contact with the other element, or there may be one or more intervening elements present. In contrast, when an element is described as “directly” located “on”, “directly attached” to, “directly connected” to, “directly coupled” to or “in direct contact with” another element, there are no intervening elements present. In the description, references that a first element is arranged “adjacent” a second element can mean that the first element has a part that overlaps the second element or a part that is located above or below the second element.

Herein, the foregoing description may refer to elements or nodes or features being “connected” or “coupled” together. As used herein, unless expressly stated otherwise, “connected” means that one element/node/feature is electrically, mechanically, logically or otherwise directly joined to (or directly communicates with) another element/node/feature. Likewise, unless expressly stated otherwise, “coupled” means that one element/node/feature may be mechanically, electrically, logically or otherwise joined to another element/node/feature in either a direct or indirect manner to permit interaction even though the two features may not be directly connected. That is, “coupled” is intended to encompass both direct and indirect joining of elements or other features, including connection with one or more intervening elements.

Herein, terms such as “upper”, “lower”, “left”, “right”, “front”, “rear”, “high”, “low” may be used to describe the spatial relationship between different elements as they are shown in the drawings. It should be understood that in addition to orientations shown in the drawings, the above terms may also encompass different orientations of the device during use or operation. For example, when the device in the drawings is inverted, a first feature that was described as being “below” a second feature can be then described as being “above” the second feature. The device may be oriented otherwise (rotated 90 degrees or at other orientation), and the relative spatial relationship between the features will be correspondingly interpreted.

Herein, the term “A or B” used through the specification refers to “A and B” and “A or B” rather than meaning that A and B are exclusive, unless otherwise specified.

The term “exemplary”, as used herein, means “serving as an example, instance, or illustration”, rather than as a “model” that would be exactly duplicated. Any implementation described herein as exemplary is not necessarily to be construed as preferred or advantageous over other implementations. Furthermore, there is no intention to be bound by any expressed or implied theory presented in the detailed description.

Herein, the term “substantially”, is intended to encompass any slight variations due to design or manufacturing imperfections, device or component tolerances, environmental effects and/or other factors. The term “substantially” also allows for variation from a perfect or ideal case due to parasitic effects, noise, and other practical considerations that may be present in an actual implementation.

Herein, certain terminology, such as the terms “first”, “second” and the like, may also be used in the following description for the purpose of reference only, and thus are not intended to be limiting. For example, the terms “first”, “second” and other such numerical terms referring to structures or elements do not imply a sequence or order unless clearly indicated by the context.

Further, it should be noted that, the terms “comprise”, “include”, “have” and any other variants, as used herein, specify the presence of stated features, steps, operations, elements, and/or components, but do not preclude the presence or addition of one or more other features, steps, operations, elements, components, and/or groups thereof.

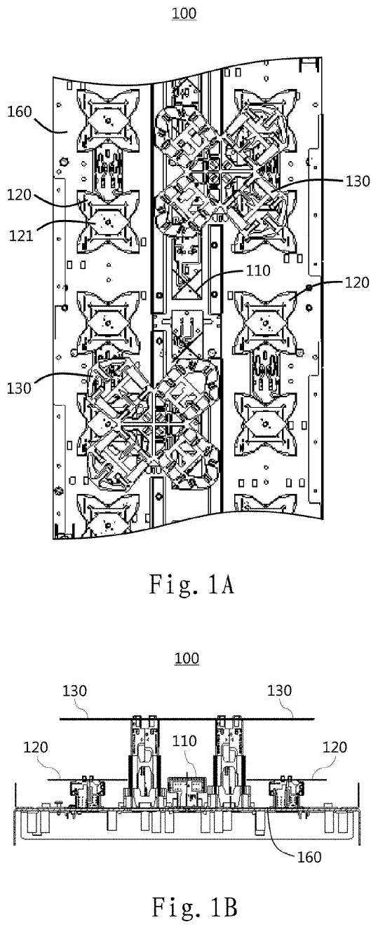

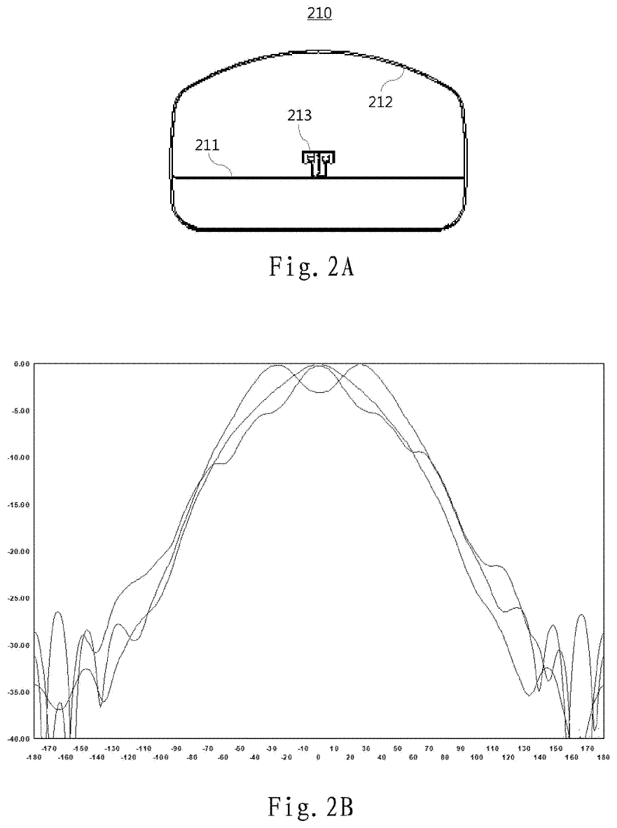

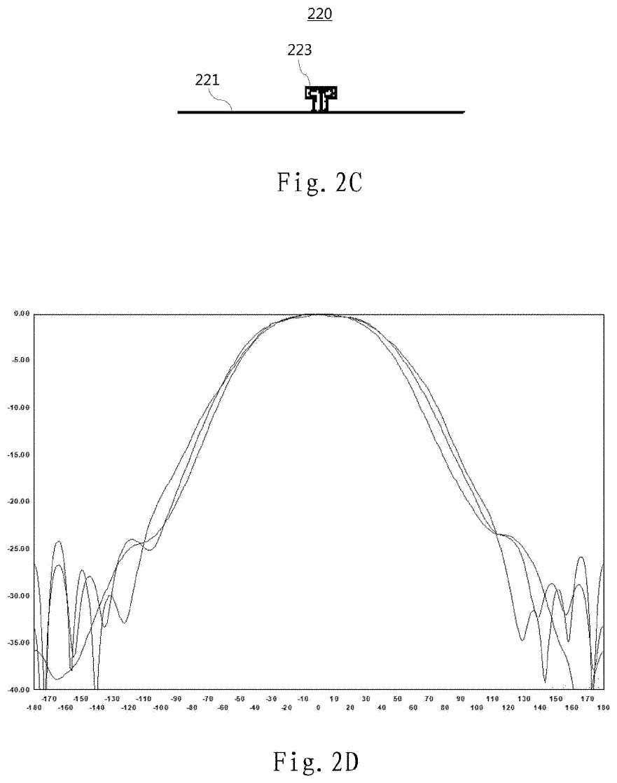

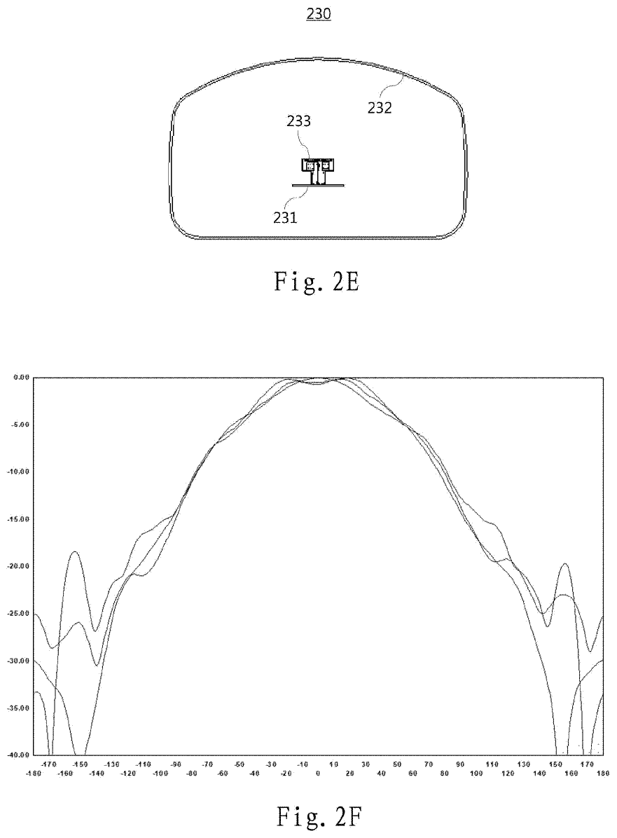

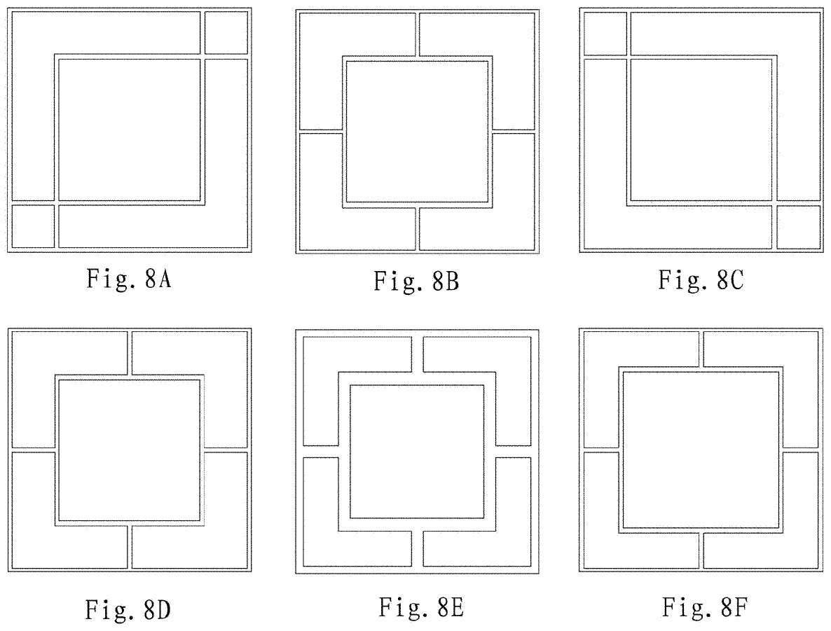

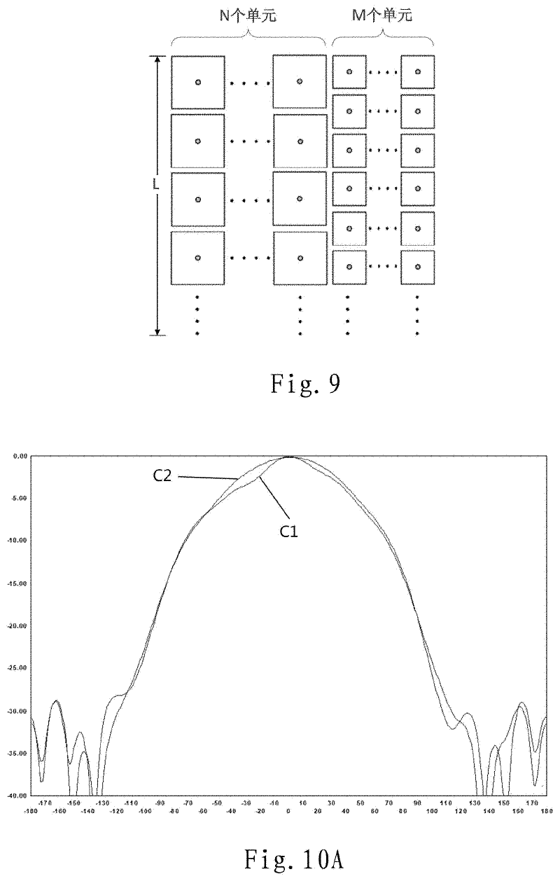

The radiation patterns generated by the array of radiating elements 110 of antenna assembly 100 of FIG. 1A and FIG. 1B may be distorted when the antenna assembly 100 is inserted into a radome to form an antenna. This distortion may appear, for example, at and/or near the boresight pointing direction of the array of radiating elements 110, as shown by curves C1, C3, and C5 in FIGS. 8A-8C. In a simulation experiment, the inventors removed other elements (including all the radiating elements 120, 130 and parasitic elements used for these radiating elements, etc.) on the front side of the reflector 160 of antenna assembly 100 except for the array of radiating elements 110, such that an antenna model 210 for the simulation experiment shown in FIG. 2A was obtained. The antenna model 210 includes a reflector 211 similar to the reflector 160 in the antenna assembly 100, an array of radiating elements 213 similar to the array of radiating elements 110, and a radome 212. The radiation patterns generated by the array of radiating elements 213 in the antenna model 210 measured in the simulation experiment is shown in FIG. 2B, where the three curves represent the intensity of the radiation pattern as a function of azimuth angle at frequencies of 3.1 GHz, 3.6 GHz, and 4 GHz, respectively. It can be seen that, similar to the radiation pattern of the array generated by radiating elements 110 in the antenna (including a radome) including the antenna assembly 100, the radiation pattern of the array of radiating elements 213 in the antenna model 210 is also distorted at and/or near the boresight pointing direction.

In another simulation experiment, the inventors removed the radome 212 in the antenna model 210 so as to obtain an antenna model 220 for the simulation experiment shown in FIG. 2C. The antenna model 220 includes a reflector 221 similar to the reflector 160 in the antenna assembly 100, and an array of radiating elements 223 similar to the array of radiating elements 110. The radiation patterns generated by the array of radiating elements 223 in the antenna model 220 measured in the simulation experiment are shown in FIG. 2D, in which the three curves represent the intensity of the radiation pattern as a function of azimuth angle at frequencies of 3.1 GHz, 3.6 GHz and 4 GHz, respectively. It can be seen that, unlike the radiation pattern of the array of radiating elements 110 in the antenna (including the radome) including the antenna assembly 100, the radiation pattern of the array of radiating elements 223 in the antenna model 220 without a radome is not distorted near the boresight pointing direction.

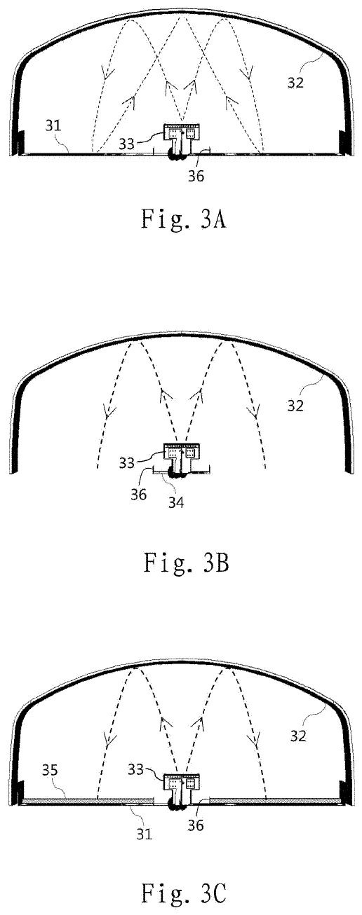

Accordingly, the inventors believed that the distortion of the radiation pattern of the array of radiating elements 110 in the antenna (including a radome) including the antenna assembly 100 might be caused by reflections of electromagnetic waves between the radome and the reflector. As shown in FIG. 3A, the electromagnetic radiation emitted by the radiating elements 33 travels forwardly to the radome 32. A portion of the electromagnetic radiation does not pass through the radome 32 to radiate forwardly, but instead is reflected by the radome 32 such that it is redirected to travel backwardly (a possible path of such an electromagnetic wave is schematically shown in broken lines in the figure, and the arrows on it indicate the traveling direction of the electromagnetic radiation). The reflected electromagnetic radiation may travel backwardly to the reflector 31 and is reflected by the reflector 31 to be redirected to travel forwardly, such that it is superimposed with electromagnetic radiation that is subsequently emitted directly from the radiating elements 33. The superimposed electromagnetic radiation will not be in-phase with the subsequently emitted electromagnetic radiation and hence may not constructively combine, resulting in distortions in the radiation pattern generated by the array of radiating elements 33.

In another simulation experiment, the inventors reduced a width of the reflector 211 in antenna model 210 such that the width of the reflector 211 was substantially a width required by the array of radiating elements 233. The resulting antenna model 230 for the simulation experiment is shown in FIG. 2E. The antenna model 230 includes a reflector 231 that is significantly narrower than the reflector 211 in antenna model 210, an array of radiating elements 233 similar to the array of radiating elements 213 in the antenna model 210, and a radome 232 similar to the radome 212 in the antenna model 210. FIG. 3B shows a situation similar to that in antenna model 230. Electromagnetic radiation emitted by the array of radiating elements 33 travels forwardly to the radome 32. A portion of the electromagnetic radiation is reflected by the radome 32 so that it travels backwardly. Much of the reflected electromagnetic radiation, however, may not reach the reflector 34 due to the reduced width thereof, and therefore will not be redirected by the reflector 34 so as not to be superimposed on electromagnetic radiation that is emitted directly by the array of radiating elements 33. Radiation patterns of the array of radiating elements 233 in the antenna model 230 measured in the simulation experiment are shown in FIG. 2F, in which the three curves represent the intensity of the radiation pattern as a function of azimuth angle at frequencies of 3.1 GHz, 3.6 GHz and 4 GHz, respectively. It can be seen that, in the vicinity of the boresight pointing direction of the array of radiating elements 233, the radiation pattern of the array of radiating elements 233 in the antenna model 230 with a narrower reflector 231 is much better than the radiation pattern of the array of radiating elements 213 in the antenna model 210 with a wider reflector 211, although it is not as smooth as the radiation pattern of the array of radiating elements 223 in the antenna model 220 without a radome.

According to the above simulation experiments, it may be determined that at least one reason for the distortion of the radiation pattern of the array of radiating elements 110 in the antenna assembly 100 is that the reflector 160 is too wide for the array. One solution for this is to narrow the reflector 160 so as to fit the width of the array of radiating elements 110, as shown in FIGS. 2E and 3B. However, in a multi-array antenna, the reflector serves not only one of the arrays but all arrays in the multi-array antenna. For example, in the antenna assembly 100, in addition to the array of radiating elements 110, the reflector 160 serves the array of radiating elements 120 and the array of radiating elements 130. Therefore, the actual width of the reflector 160 may not be reduced to the width suitable only for the array of radiating elements 110.

Antennas according to embodiments of the present invention may solve the above problem. As shown in FIG. 3C, an antenna according to an embodiment of the present invention includes a reflector 31, an array of radiating elements 33, a reflection reducing component 35, and a radome 32. The array of radiating elements 33 includes a column of radiating elements 33 extending substantially in a longitudinal direction of the reflector 31. Each radiating element 33 may include a feed/support stalk extending forwardly from the reflector 31, and a radiating arm extending substantially parallel to the reflector 31 and being configured to emit electromagnetic radiation within a first frequency band. The radiating elements 33 may each be cross-dipole radiating elements in some embodiments that radiate at two different polarizations. In other embodiments, other types of radiating elements may be used such as, for example, patch radiating elements. The reflection reducing component 35 is configured such that electromagnetic radiation within the first frequency band that is reflected by the reflection reducing component 35 is weaker than electromagnetic radiation within the first frequency band that is reflected by the portion of the reflector 31 that is covered by the reflection reducing component 35. The reflection reducing component 35 may reduce or weaken a reflection by the portion of the reflector 31 that is covered by the reflection reducing component 35 to the electromagnetic radiation within the first frequency band by at least 30% (for example, approximately by 30%, 50%, 80%, etc.). The reflection reducing component 35 is provided on a front surface of the reflector 31 and is located on the left and right sides of the array of radiating elements 33 in a front view of the antenna. Similar to the case of the reflector 34 having a reduced width shown in FIG. 3B, in this embodiment, electromagnetic radiation emitted by the array of radiating elements 33 travels forwardly to the radome 32, and a portion of the electromagnetic radiation is reflected backwardly by the radome 32. The backwardly reflected electromagnetic radiation may pass to the reflection reducing component 35, and will not be completely redirected to travel forwardly, such that the reflected electromagnetic radiation will not be completely superimposed on an electromagnetic wave emitted directly from the radiating element 33. Therefore, the radiation pattern of the array of radiating elements 33 may be improved.

A first portion of the reflector 31 that is not covered by the reflection reducing component 35 is an effective portion for the array of radiating elements 33. For a radiating element array, the width of the effective portion of the reflector that is required may, for example, be slightly larger than the width of the array of radiating elements 33. For example, the width of the reflector (that is, the width of the effective portion) that is required by a column of radiating elements may be 0.6 to 1.2 times the wavelength (herein referred to as “center wavelength”) corresponding to the center frequency of the electromagnetic radiation emitted by the radiating element (the lateral distance from the phase center of the radiating element to the boundary of the effective portion is 0.3 to 0.6 times the center wavelength), typically 0.8 to 1 times the center wavelength (the lateral distance from the phase center of the radiating element to the boundary of the effective portion is 0.4-0.5 times the center wavelength). If space is limited, the width of the effective portion may be further reduced to 0.5 to 0.6 times the center wavelength (the distance from the phase center of the radiating element to the boundary of the effective portion is 0.25 to 0.3 times the center wavelength), and a conductor 36 (conductive element) as a parasitic element extending forwardly from the reflector at the boundary of the effective portion may be added so as to compensate for a lack of the width of the effective portion. In the embodiment shown in FIG. 3C, a reflection reducing component 35 may be provided on a front surface of a second portion of the reflector 31 other than the effective portion for the array of radiating elements 33. It will be appreciated that, in another embodiment, the reflection reducing component 35 may be provided only on a front surface of a third portion of the reflector 31 near the effective portion (for example, the region A5 described below). The reflecting reducing component 35 may weaken a surface current on the reflector 31 that is excited by the electromagnetic radiation emitted by the radiating elements 33, such that the second portion of the reflector 31 will reflect less electromagnetic radiation emitted by the radiating elements 33, and the radiation pattern of the array of radiating elements 33 may therefore be improved.

In the illustrated embodiment, the reflection reducing component 35 is located on the front surface of the reflector 31. It will be appreciated that, in another embodiment, the reflection reducing component 35 may be located on a front side of the reflector 31 and on a rear side of the radiation arms of the radiating elements 33, that is, it is located between the reflector 31 and the radiating arms of the radiating elements 33 along the front-back direction. In the illustrated embodiment, the reflection reducing component 35 is located on both the left side and the right side of the array of radiating elements 33. It will be appreciated that, in another embodiment, the reflection reducing component 35 may only be provided on one side of the array of radiating elements 33, which may also improve the radiation pattern of the array of radiating elements 33.

In the multi-band antenna, in order to reduce an impact of the reflection reducing component 35 on the array of other radiating elements included in the antenna assembly, the reflection reducing component 35 is further configured substantially not to reduce or weaken the reflection by the portion of the reflector 31 that is covered by the reflection reducing component 35 to the electromagnetic radiation within the second frequency band different from the first frequency band. The term “substantially not to reduce” or “substantially not to weaken” used in the present invention refers to not reduce or weaken at all, and to reduce or weaken less than or substantially equal to 5%.

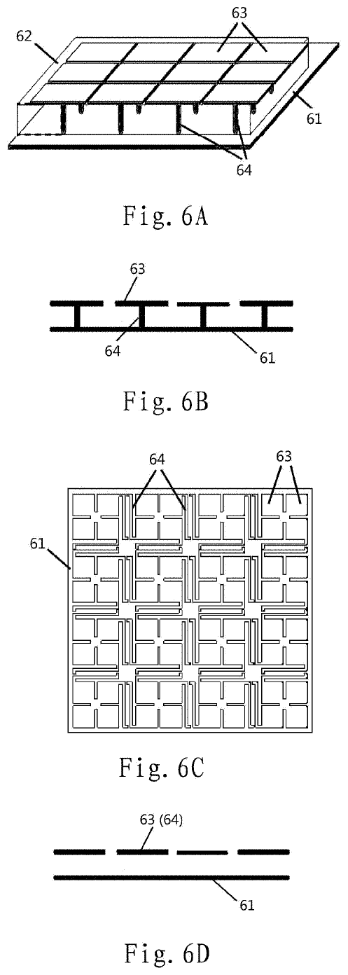

In one embodiment, the reflection reducing component 35 may include an absorbing material for electromagnetic radiation within the first frequency band. In another embodiment, the reflection reducing component 35 may have a high impedance with respect to electromagnetic radiation in the first frequency band, such that the electromagnetic radiation within the first frequency band excites relatively weak surface currents in the reflection reducing component 35, such that the reflection reducing component 35 may reduce the reflection by the reflector 31 itself to the electromagnetic radiation within the first frequency band. In this embodiment, the reflection reducing component 35 and the portion of the reflector 31 that is covered by the former may form an electromagnetic band gap (EBG) structure. The reflectivity of the EBG structure to the electromagnetic radiation within the first frequency band may be lower than the reflectivity of the reflector 31 to the electromagnetic radiation within the first frequency band (in the case where the incident angles of the electromagnetic radiation within the first frequency band with respect to the EBG structure and the reflector 31 are the same). As shown in FIGS. 6A to 6D, the EBG structure includes a ground plane 61, a dielectric plate 62 on the ground plane 61, and a conductor unit array. The conductor unit array includes a plurality of conductor units that are arranged in an array at substantially equal intervals therebetween, and each conductor unit includes a capacitive element 63 and an inductive element 64 that are electrically connected to each other, such that the conductor unit array has a relatively high impedance within the first frequency band. In the above embodiment, the reflector 31 may act as the ground plane 61, and the reflection reducing component 35 may include the conductor unit array and the dielectric plate that is located on the front surface of the reflector 31.

FIGS. 6A and 6B show an EBG structure. The conductor unit array includes a plurality of “mushroom-shaped” conductor units arranged in an array. The capacitive element 63 in each conductor unit is located on a front surface of the dielectric plate 62. The inductive element 64 in each conductor unit passes through the dielectric plate 62 along the thickness direction of the dielectric plate 62, and electrically connects the ground plane to the capacitive element 63 corresponding to the inductive element 64. A via may be opened through the dielectric plate 62, the dimension of the via may be much smaller than the dimension of the capacitive element 63, and the inductive element 64 may be implemented as a conductor filled in the via or a metal (for example copper) that plates the wall of the via. Capacitors are formed between adjacent capacitive elements 63 and/or between the capacitive element 63 and the ground plane 61, and these capacitors, in combination with the inductive elements 64, form LC circuits, which may have a high impedance for target frequencies so as to suppress the surface current within these frequencies. The conductor units form a periodic arrangement in the array in order to suppress the surface current. The more conductor units that are arranged periodically, the stronger the suppression on the surface current. When the number of periodically arranged conductor units is greater than or equal to 5, a significant suppression effect may be achieved. For example, in the embodiment where the reflective reducing component 35 is implemented as an EBG structure, on one side of the array of radiating elements 33, the number of conductor units included in the EBG structure along the lateral direction (i.e., the width direction) of the reflector 31 is greater than or equal to 5.

FIG. 6C and FIG. 6D show another EBG structure. In this EGB structure, the capacitive element 63 and the inductive element 64 in each conductor unit are both located on the front surface of the dielectric plate 62. The capacitive element 63 may be implemented as a patch conductor with a large size, and the inductive element 64 may be implemented as a patch conductor with a size much smaller than that of the capacitive element 63. A capacitor is formed between adjacent capacitive elements 63, between adjacent inductive elements 64, between adjacent capacitive element 63 and inductive element 64, and/or between capacitive element 63 and the ground plane, and an inductor is formed through the inductive element 64. The number of periodically arranged conductor units may be greater than or equal to 5 so as to obtain a significant effect of suppressing the surface current.

It will be appreciated that in the EBG structure shown in FIG. 6C and FIG. 6D, there may also be an inductive element passing through the dielectric plate 62 as shown in FIG. 6A and FIG. 6B, that is, the conductor unit may include both an inductive element located on the front surface of the dielectric plate 62 and an inductive element passing through the dielectric plate 62. It will be appreciated that, the shapes and sizes of the capacitive elements and the inductive elements shown in the figures are only schematic, and the EBG structure may be implemented in other forms. The EBG structure may be easily manufactured using a PCB manufacturing process, and the cost is low.

When designing the EBG structure, the equivalent capacitance and inductance values may be calculated based on the target frequency (for example, the center frequency of the operating band of the array of radiating elements 33) so as to determine the shape and the size of the capacitive and inductive elements in the EBG structure, such that the EBG structure may significantly suppress a current at the target frequency. The relative bandwidth of the target frequency for an EBG structure (the ratio of the difference between the highest frequency and the lowest frequency of the frequency band to the center frequency) is typically 5%-7%, while the relative bandwidth of a radiating element may be larger, typically 30%-50% (for example, the relative bandwidth of the radiating element 110 in the antenna assembly 100 is about 30%). Therefore, in order to suppress the surface current for the entire frequency band of the radiating element 110, it may be necessary to enable the EBG structure to operate over a wider frequency band.

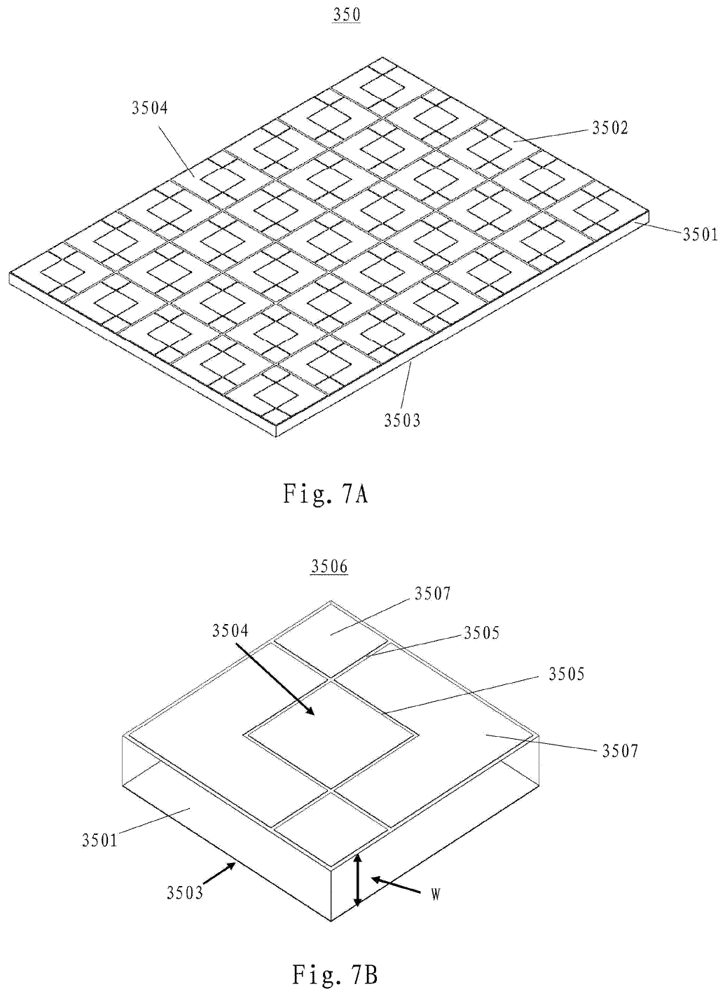

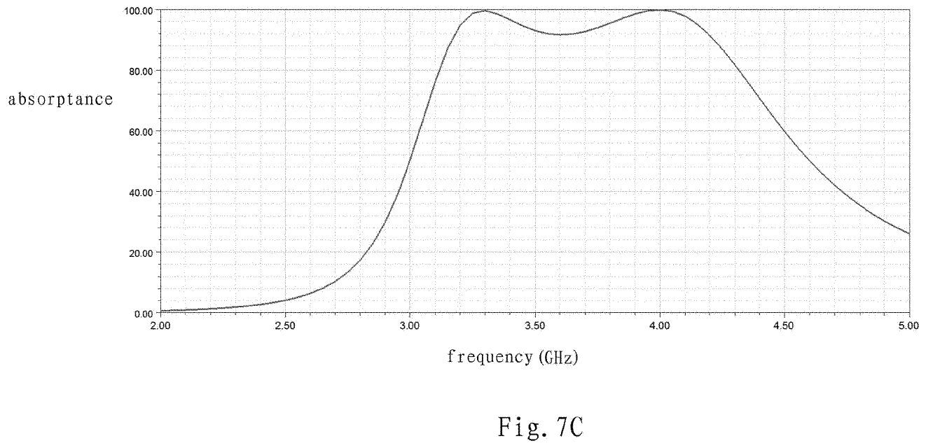

Next, the reflection-reducing component 350 in an antenna according to yet another embodiment of the present disclosure will be described with reference to FIGS. 7A-7C.

FIG. 7A shows a perspective view of at least a part of the reflection-reducing component 350 in the antenna according to yet another embodiment of the present disclosure. The reflection-reducing component 350 may be configured as a wave absorber based on a printed circuit board, which may include a dielectric layer 3501, a metallic pattern 3502 arranged on the first major surface of the dielectric layer 3501, and a ground layer 3503 arranged on the second major surface of the dielectric layer 3501 opposite to the first major surface. The ground layer 3503 is formed as a copper clad layer printed on the second major surface of the dielectric layer 3501. In other embodiments, the reflection-reducing component 350 may also be composed of periodically arranged metallic patch elements.

The metallic pattern 3502 in the reflection-reducing component 350 may include a plurality of pattern elements 3504. By periodically arranging these pattern elements 3504 in a one-dimensional array or a two-dimensional plane, a metamaterial absorber with a specific absorptance distribution can be formed. The absorptance distribution of the reflection-reducing component 350 can be understood as a change curve of the absorptance of the reflection-reducing component 350 with respect to frequency. Absorptance can be understood as the percentage of electromagnetic radiation absorbed when incident on the reflection-reducing component 350 at a predetermined incident angle (for example, at a vertical incident angle or a specific oblique incident angle, such as 60 degrees) to the total electromagnetic radiation incident on the reflection-reducing component 350.

The reflection-reducing component 350 may be designed to be frequency selective. In other words, when electromagnetic waves are incident on the reflection-reducing component 350, the reflection-reducing component 350 can exhibit different electromagnetic characteristics for electromagnetic waves of different frequencies, for example, it can selectively absorb, reflect or pass electromagnetic waves of different frequencies. The reflection-reducing component 350 may be configured to reduce the reflection of the incident electromagnetic radiation within the first frequency band more than the reflection of the incident electromagnetic radiation within the second frequency band at a predetermined incident angle. In other words, the reflection-reducing component 350 may be configured to have higher absorptance of the incident electromagnetic radiation within the first frequency band than the incident electromagnetic radiation within the second frequency band at a predetermined incident angle.

In order to reduce the impact of the reflection-reducing component 350 on other radiating element arrays included in the antenna assembly 100, the reflection-reducing component 350 may not substantially absorb the incident electromagnetic radiation within the second frequency band. Therefore, the electromagnetic radiation within the second frequency band may be substantially reflected by the ground layer 3503 and/or reflector 160 or at least partially reflected by the ground layer 3503. In other words, the reflection-reducing component 350 is also configured to not substantially reduce or weaken the reflection of electromagnetic radiation within the second frequency band, which is different from the first frequency band by the area of the reflector 160 covered by the reflection-reducing component 350.

“To not substantially absorb” as stated in the present disclosure means no absorption at all, and the absorptance is less than or substantially equal to 5%. “To not substantially reduce” as stated in the present disclosure means no reduction or weakening at all, and the reduction or weakening is less than or substantially equal to 5%.

In some embodiments, the first frequency band may be any frequency band higher than 2 GHz or 3 GHz, and the second frequency band may be any frequency band lower than the first frequency band. This is in view of the fact that relatively high-frequency electromagnetic waves are more likely to be scattered by the radome, thereby causing multipath transmission of electromagnetic waves and such multi-path transmission will cause the radiation pattern of the corresponding electromagnetic beam to be deformed. In some embodiments, the first frequency band is 3.1-4.2 GHz or a sub-band thereof. The second frequency band may be 1427-2690 MHz or a sub-band thereof and/or 617-960 MHz or a sub-band thereof.

FIG. 7B shows a schematic perspective view of the unit structure 3506 of the reflection-reducing component 350. Each unit structure 3506 may include a pattern element 3504 and a corresponding dielectric layer 3501 and ground layer 3503. The pattern element 3504 may include a plurality of sub-regions 3507 that are structurally completely separated from one another via a plurality of slits 3505. The slits 3505 can be understood as non-metallic regions in the metallic pattern 3502. Therefore, each sub-region 3507 of the pattern element 3504 can be formed as an independent metallic island via the corresponding slits 3505, so that there is no metallic connection part between each sub-region 3507.

Each unit structure 3506, that is, the pattern element 3504 on the first major surface of the dielectric layer 3501 together with the corresponding dielectric layer 3501 and the copper clad layer on the second major surface of the dielectric layer 3501 and/or the reflector, can form a resonant cavity. The resonant cavity, based on its own structural design—for example, the size of each sub-region 3507 and slits 3505 in the pattern element 3504, and the thickness and the material (such as dielectric constant, loss tangent, etc.) of the dielectric layer 3501—can at least partially confine the electromagnetic radiation within the resonant frequency band that matches the resonant cavity, and leverage on the material loss characteristics of the dielectric layer 3501 to deplete the electromagnetic radiation, so that the resonant cavity can at least partially absorb the incident electromagnetic radiation within the specific frequency band (for example, the aforementioned first frequency band).

FIG. 7C shows an exemplary absorptance graph of the reflection-reducing component 350 at a predetermined incident angle. It can be seen from FIG. 7C that the absorption band of the reflection-reducing component 350 with an absorptance greater than 90% can cover 3.15 GHz to 4.25 GHz. The absorption band can basically cover the operating frequency band (3.1-4.2 GHz) of the specific radiating element 110 (with an operating frequency band of more than 3 GHz), for example, the high-frequency radiating element 110 in the aforementioned multiband antenna. At the same time, it can be seen that the absorptance of the reflection-reducing component 350 in the medium frequency band (for example, 1427-2690 MHz) and the low frequency band (617-960 MHz) is significantly reduced to less than 5%. Therefore, the reflection-reducing component 350 can be applied to a multiband antenna, so that the reflection-reducing component 350 cannot only reduce the multipath transmission effect of high-frequency electromagnetic radiation and improve the radiation pattern generated by the array of high-frequency radiating elements 110, but can also basically avoid any negative impact on medium-frequency electromagnetic radiation and low-frequency electromagnetic radiation.

In addition, it is advantageous to configure the reflection-reducing component 350 according to some embodiments of the present disclosure as a wave absorber based on a printed circuit board, because the reflection-reducing component 350 based on a printed circuit board can be improved in terms of space utilization and/or cost as compared to the traditional wave-absorbing materials.

Additionally or alternatively, absorptance graph of the reflection-reducing component 350 may have several peak values to at least partially absorb the incident electromagnetic radiation within several sub-bands of the first frequency band. In some embodiments, the metallic pattern comprises an array of first pattern elements and an array of second pattern elements, wherein the array of first pattern elements is configured to at least partially absorb the incident electromagnetic radiation within a first sub-band of the first frequency band, and the array of second pattern elements is configured to at least partially absorb the incident electromagnetic radiation within a second sub-band of the first frequency band.

Traditional wave-absorbing materials are usually a kind of engineering materials with loss characteristics. Their main working principle is to leverage on the loss characteristics of the absorbing materials to convert the incident electromagnetic wave energy into heat or other forms of energy for consumption, thereby effectively absorbing or attenuating the incident electromagnetic waves. At present, conventional wave-absorbing material products are mainly composed of matrix material (or adhesive) and electromagnetic wave-absorbing medium; wherein the main function of the matrix material is to achieve impedance matching, so that incident electromagnetic waves enter the material without reflection as much as possible and then the electromagnetic waves that entered the wave-absorbing material are attenuated as much as possible by leveraging on the electromagnetic loss characteristics of the absorbing medium. However, in order to achieve higher absorptance, a thicker wave-absorbing material (for example, a thickness of at least ¼ wavelength) is required, which occupies a larger space and therefore reduces the space utilization within the base station antenna. In addition, the introduction of wave-absorbing materials will also increase the manufacturing cost of base station antennas.

Different from traditional wave-absorbing materials, the reflection-reducing component 350 according to some embodiments of the present disclosure can achieve higher absorptance with lesser thickness. The thickness W of the dielectric layer 3501 of the reflection-reducing component 350 may be between 1 mm and 10 mm or between 2 mm and 5 mm. The material of the dielectric layer 3501 of the reflection-reducing component 350 may be an FR-4 substrate, an FR-1 substrate, an FR-2 substrate, or a CEM substrate. In the current embodiment, the thickness W of the dielectric layer 3501 of the reflection-reducing component 350 may be about 3 mm, and the dielectric layer 3501 of the reflection-reducing component 350 may be an FR-4 substrate.

It should be understood that the absorptance distribution of the reflection-reducing component 350 can be adaptively designed according to specific application scenarios. The absorptance distribution of the reflection-reducing component 350, for example, the absorptance and/or absorption bandwidth of the reflection-reducing component 350 for incident electromagnetic radiation within a specific frequency band, can be adjusted by changing one or more of the following parameters: (1) the thickness W of the dielectric layer 3501, (2) the material of the dielectric layer 3501, (3) the width of the slit 3505, (4) the shape of each sub-region 3507 in the pattern element 3504, (5) the arrangement of the sub-regions 3507 in the pattern element 3504, (6) the number of pattern elements 3504, and (7) the arrangement of the pattern elements 3504.

FIGS. 8A-8F show the example variants of the pattern element 3504 of the reflection-reducing component 350 according to some embodiments of the present disclosure. These variants are respectively modified according to parameters such as the width of slit 3505, the shapes of sub-regions 3507, and the arrangement of sub-regions 3507, so as to adjust the absorptance distribution of the reflection-reducing component 350. FIGS. 8A, 8B, and 8C exemplarily show three different types of arrangement of sub-regions 3507. These sub-regions 3507 may involve L-shaped sub-regions 3507 and square sub-regions 3507, and may be arranged symmetrically. FIGS. 8D, 8E, and 8F exemplarily show three different types of the width of slit 3505. By changing the width of slit 3505, the absorptance distribution of the reflection-reducing component 350, for example, the absorptance and/or absorption bandwidth of the reflection-reducing component 350 for incident electromagnetic radiation within a specific frequency band, can be adjusted. In addition, by adjusting the width of slit 3505, the resonant frequency and absorption bandwidth of the wave absorber can also be changed. It should be understood that, in other embodiments, the reflection-reducing component 350 may have a different number of sub-regions 3507, a different arrangement of the sub-regions 3507, and/or a different shape of the sub-regions 3507, etc.

In some application scenarios, the impact of the wave absorption function of the reflection-reducing component 350 on the gain of the array of high-frequency radiating elements 110 should also be considered. Experiments have shown that: the mounting position of the reflection-reducing component 350 will impact the gain of the array of high-frequency radiating elements 110. In other words, the distance between the reflection-reducing component 350 and the array of high-frequency radiating elements 110 will impact the gain. Therefore, in order to reduce the multipath transmission effect of high-frequency electromagnetic radiation while not significantly impacting the gain of the array of high-frequency radiating elements 110, the distance between the reflection-reducing component 350 and the array of high-frequency radiating elements 110 may be changed, so that the negative effect may be reduced while maintaining a good gain.

In some embodiments, the reflection-reducing component 350 may be arranged on an area of the reflector 160 away from the high-frequency radiating element 110. In other words, the reflection-reducing component 350 may not cover the area near the high-frequency radiating element 110, so as to ensure that the electromagnetic waves of the high-frequency radiating element 110 incident on the area can still be reflected forward by the reflector 160, thereby avoiding significant impact on the gain.

FIG. 9 shows a conductor unit array in yet another EBG structure. The EBG structure having such a conductor unit array may support a wider frequency band. The conductor unit array includes a first sub-array and a second sub-array which are laterally adjacent each other. The first sub-array is configured to suppress currents at frequencies within a first frequency band, and the second sub-array is configured to suppress currents at frequencies within a second frequency band, such that the combined conductor unit array may be configured to suppress currents at frequencies within both the first and second frequency bands. For example, in an embodiment in which the reflection reducing component 35 is implemented as an EBG structure supporting a wider frequency band, at least a part of the operating frequency band of the radiating element 33 may be divided into a first sub-band and a second sub-band. The first sub-band and the second sub-band may be adjacent, spaced, or partially overlapped in different embodiments of the present invention. The impedance of the first sub-array in the conductor unit array of the EBG structure within the first sub-band is higher than that of the reflector 31, and the impedance of the second sub-array within the second sub-band is higher than that of the reflector 31. FIG. 9 is a front view of the reflection reducing component 35 on one side of the array of radiating elements 33. Along the lateral direction of the reflector 31, the first sub-array includes N conductor units, and the second sub-array includes M conductor units, wherein M and N are greater than or equal to 5. The sizes and/or shapes of the conductor units from different sub-arrays may be different. Along the longitudinal direction of the reflector 31 (that is, the extending direction of the array of radiating elements 33), the lengths of the first sub-array and the second sub-array may both be L, where L may be greater than or substantially equal to the length of the array of radiating elements 33. It will be appreciated that, the conductor unit array in the EBG structure supporting a wider frequency band may include more sub-arrays aiming at respective frequency bands (sub-bands).

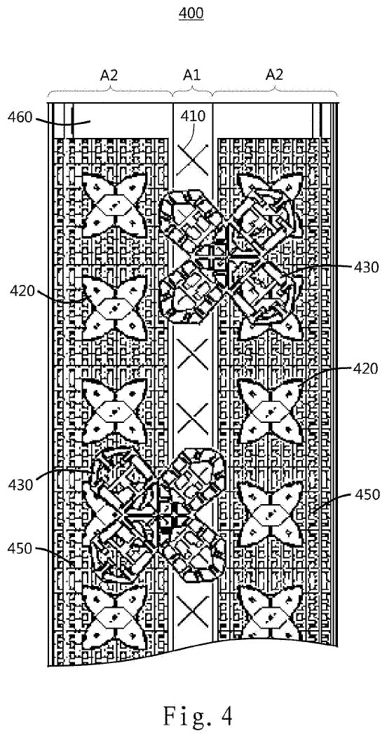

FIG. 4 is a front view of a multi-band antenna assembly 400 according to an embodiment of the present invention. The multi-band antenna assembly 400 includes a reflector 460, an array of radiating elements 410 having a first operating frequency band (for example, 3.1 to 4.2 GHz or a sub-band thereof), an array of radiating elements 420 having a second operating frequency band (for example, 1695 to 2690 MHz or a sub-band thereof), an array of radiating elements 430 having a third operating frequency band (for example, 694 to 960 MHz or a sub-band thereof), and a reflection reducing component 450. The reflector 460 includes non-overlapping (when viewed from the front) regions A1 and A2, where the region A1 is located in the middle, and region A2 extends from each side of region A1 away from region A1 to the respective sides of the reflector 460. Along the longitudinal direction of the reflector 460, the array of radiating elements 410 extends in the entire region A1, the array of radiating elements 420 extends in the entire region A2, the array of radiating elements 430 extends in the entire reflector 460, and the reflection reducing component 450 extends in the entire region A2. The reflection reducing component 450 reduces the width of the effective portion of the reflector for the array of radiating elements 410 to the width of region A1.

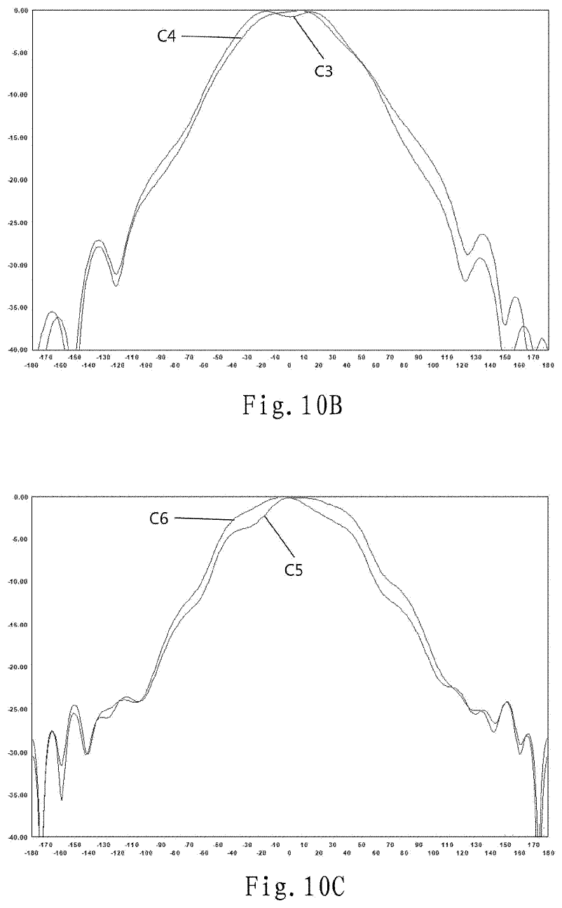

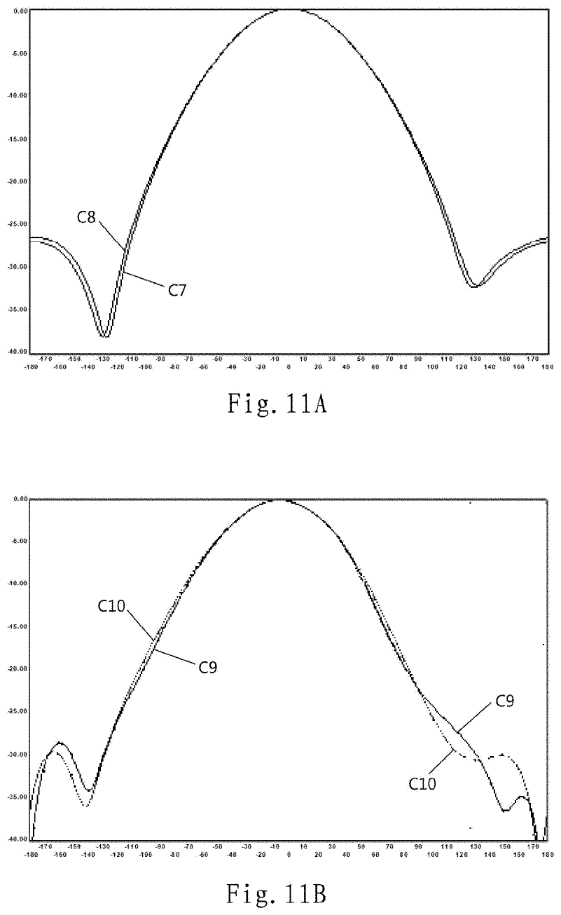

FIG. 10A to FIG. 10C are graphs of the simulated radiation patterns for antennas including radomes at frequencies of 3.1 GHz, 3.6 GHz, and 4 GHz, respectively, as a function of azimuth angle. These three frequencies are all frequencies within the operating frequency band of the radiating element 410 (or radiating element 110). Curves C1, C3, C5 correspond to radiation patterns of the array of radiating elements 110 in the antenna including the antenna assembly 100 shown in FIG. 1A. Curves C2, C4, C6 correspond to radiation patterns of the array of radiating elements 410 in the antenna including the antenna assembly 400 shown in FIG. 4. The reflection reducing component 450 in the antenna assembly 400 is implemented as the EBG structure shown in FIGS. 6A and 6B, where the target frequency of the EGB structure is the 3.65 GHz center frequency of the 3.1˜4.2 GHz operating frequency band. It can be seen that the radiation patterns of the array of radiating elements 410 in the antenna assembly 400 are improved compared to the radiation patterns of the array of radiating elements 110 in the antenna assembly 100.

In order to test the impact of the reflection reducing component on the other radiating element arrays included in the antenna assembly, the inventors also simulated radiation patterns generated by the other radiating element arrays. FIGS. 11A and 11B are graphs showing the intensity of electromagnetic radiation of antennas including radomes at two frequencies of 806 MHz and 1.695 GHz, respectively, as a function of azimuth angle. 806 MHz is a frequency within the operating frequency band of the radiating element 430 (or radiating element 130). Curve C7 corresponds to the radiation pattern generated by the array of radiating elements 130 in the antenna including the antenna assembly 100 shown in FIG. 1A, and curve C8 corresponds to the radiation pattern generated by the array of radiating elements 430 in the antenna including the antenna assembly 400 shown in FIG. 4, 1.695 GHz is a frequency within the operating frequency band of the radiating element 420 (or radiating element 120). Curve C9 corresponds to the radiation pattern generated by the array of radiating elements 120 in the antenna including the antenna assembly 100 shown in FIG. 1A, and curve C10 corresponds to the radiation pattern generated by the array of radiating elements 430 in the antenna including the antenna assembly 400 shown in FIG. 4. In the antenna assembly 400, the reflection reducing component 450 is implemented as the EBG structure shown in FIGS. 6A and 6B, and the frequency it targets is the 3.65 GHz center frequency of the 3.1 to 4.2 GHz operating frequency band. It can be seen that the reflection reducing component 450 for the array of radiating elements 410 in the antenna assembly 400 has a small influence on the radiation patterns of other radiating element arrays (that is, the array of radiating elements 420, 430).

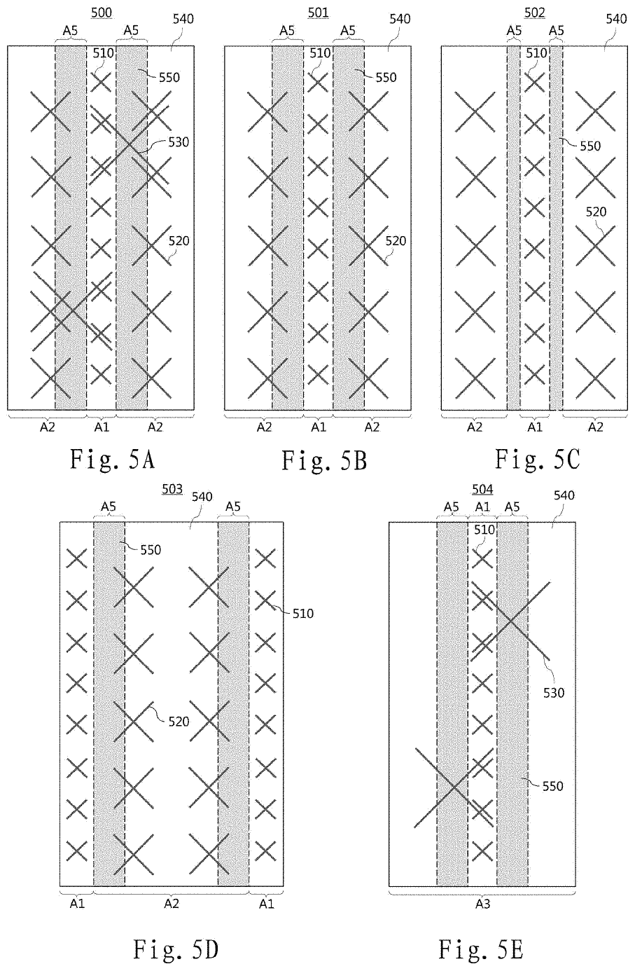

In some embodiments, the reflection reducing component 450 may not extend in the entire region A2. The reflection reducing component 450 may be provided in a portion of region A2 that is close to the region A1 so as to cut off/weaken the surface current on the reflector 460 that is excited by the electromagnetic radiation emitted by the radiating element 410, such that the radiation pattern of the array of radiating elements 410 is improved. FIG. 5A shows a multi-band antenna assembly 500. The antenna assembly 500 includes a reflector 540, arrays of radiating elements 510 through 530, and a reflection reducing component 550. The reflector 540 includes regions A1 and A2 that do not overlap with each other and a region A5. Region A1 is in the middle. Regions A2 and A5 extend from each side of region A1 away from region A1, respectively. Region A2 extends to each side of the reflector 540. Region A5 does not extend as far laterally as region A2, that is, region A5 partially overlaps region A2 at a portion of region A2 that is close to region A1. The array of radiating elements 510 extends in the entire region A1, the array of radiating elements 520 extends in the entire region A2, the array of radiating elements 530 extends in the entire reflector 540, and the reflection reducing component 550 extends in the entire region A5.

In an embodiment, a multi-band antenna may only include two arrays with respective operating frequency bands. FIG. 5B shows a multi-band antenna assembly 501. The antenna assembly 501 includes a reflector 540, arrays of radiating elements 510 and 520, and a reflection reducing component 550. In the antenna assembly 501, the reflector 540 includes regions A1, A2, and A5 similar to those in the antenna assembly 500. The array of radiating element 510 extends in the entire region A1, the array of radiating elements 520 extends in the entire region A2, and the reflection reducing component 550 extends in the entire region A5.

In an embodiment, the extension region of the reflection reducing component for the target radiating element array may not overlap with the extension region of another radiating element array. FIG. 5C shows a multi-band antenna assembly 502. The antenna assembly 502 includes a reflector 540, arrays of radiating elements 510 and 520, and a reflection reducing component 550. The reflector 540 includes regions A1, A2 and A5 that do not overlap with each other. Region A1 is located in the middle, region A5 extends from a side of region A1 away from the region A1, and region A2 extends away from region A5 from a side of region A5 that is further from region A1 to a side of the reflector 540. The array of radiating elements 510 extends in the entire region A1, the array of radiating elements 520 extends in the entire region A2, and the reflection reducing component 550 extends in the entire region A5.

In an embodiment, the target radiating element array may not be located in the middle of the antenna assembly. FIG. 5D shows a multi-band antenna assembly 503. The antenna assembly 503 includes a reflector 540, arrays of radiating elements 510 and 520, and a reflection reducing component 550. The reflector 540 includes regions A1 and A2 that do not overlap with each other, and a region A5. Region A2 is located in the middle of the reflector, region A1 extends from each side of region A2 away from region A2 to the respective sides of the reflector 540. Region A5 extends from each side of region A2 to the middle of region A2. Each portion of region A5 may extend for a lateral distance that is substantially equal to half a lateral width or less of the corresponding portion of region A2 (not shown). The array of radiating elements 510 extends in the entire region A1, the array of radiating elements 520 extends in the entire region A2, and the reflection reducing component 550 extends in the entire region A5.

In an embodiment, the region where the target radiating element array extends may overlap with the region where another radiating element arrays extends. FIG. 5E shows a multi-band antenna assembly 504. The antenna assembly 504 includes a reflector 540, arrays of radiating elements 510 and 530, and a reflection reducing component 550. The reflector 540 includes regions A1 and A5 that do not overlap with each other, and a region A3. Region A1 is located in the middle of the reflector 540, and region A5 extends from each side of region A1 away from region A1 by a predetermined distance but does not extend all the way to the respective sides of the reflector 540. Region A3 extends across the entire reflector 540. The array of radiating elements 510 extends throughout the entire region A1, the array of radiating elements 530 extends throughout the entire region A3, and the reflection reducing component 550 extends throughout the entire region A5.

In addition, a method for installing an antenna is also provided. When the antenna is mounted on a large mounting surface that may reflect electromagnetic radiation (for example a metal surface such as a car roof or an aircraft skin), the mounting surface may at least partially act as a reflector, so the problem being addressed in the present invention may also exist for the antenna. In this case, the above-mentioned reflection reducing component may be applied on the mounting surface. The method for installing the antenna includes: installing a reflection reducing component on the mounting surface for the antenna and on a side of the antenna. For convenience, beauty, cost, etc., the reflection reducing component may be applied only to a portion of the mounting surface that is close to the antenna. That is, the reflection reducing component is installed such that the reflection reducing component extends from a side of the antenna away from the antenna for a predetermined distance.

Although some specific embodiments of the present invention have been described in detail with examples, it should be understood by a person skilled in the art that the above examples are only intended to be illustrative but not to limit the scope of the present invention. The embodiments disclosed herein can be combined arbitrarily with each other, without departing from the scope and spirit of the present invention. It should be understood by a person skilled in the art that the above embodiments can be modified without departing from the scope and spirit of the present invention. The scope of the present invention is defined by the attached claims.

1. An antenna, comprising:
a reflector comprising a front side that includes a first region and a second region that does not overlap the first region;
a first column of radiating elements comprising at least one first radiating element that is located on the front side of the reflector and is configured to emit electromagnetic radiation within a first frequency band, the first column of radiating elements mounted to extend forwardly from the first region; and
a reflection reducing component mounted forwardly of the second region,
wherein the reflection reducing component is configured such that electromagnetic radiation within the first frequency band that is reflected by the reflection reducing component is weaker than electromagnetic radiation within the first frequency band that is reflected by the first region of the reflector.

2. (canceled)

3. The antenna according to claim 1, wherein a first impedance of the reflection reducing component within the first frequency band is higher than a second impedance of the first region of the reflector within the first frequency band, such that a surface current in the reflection reducing component that is excited by the electromagnetic radiation within the first frequency band is weaker than a surface current in the first region of the reflector that is excited by the electromagnetic radiation within the first frequency band.

4. The antenna according to claim 1, wherein
the first region has a first boundary extending along a longitudinal direction of the antenna, and a lateral distance between the first boundary and a phase center of the at least one first radiating element is 0.3 to 0.6 times a wavelength corresponding to a center frequency of the first frequency band, and
the second region extends laterally from the first boundary away from the first region.

5. The antenna according to claim 1, wherein
the first region has a first boundary extending along a longitudinal direction of the antenna, and a lateral distance between the first boundary and a phase center of the at least one first radiating element is 0.2 to 0.3 times the wavelength corresponding to the center frequency of the first frequency band,
the second region extends laterally from the first boundary away from the first region, and
the antenna further comprises a conductive element located at the first boundary and extending forwardly from the reflector.

6-7. (canceled)

8. The antenna according to claim 1, wherein the front side of the reflector further includes a third region, and the antenna further comprises:
a second column of radiating elements comprising at least one second radiating element that is configured to emit electromagnetic radiation within a second frequency band, the second column of radiating elements mounted to extend forwardly from the third region of the front side of the reflector adjacent the first column of radiating elements,
wherein the second region does not overlap the third region, and the second region is located between the first region and the third region.

9. (canceled)

10. The antenna according to claim 3, wherein the reflection reducing component and the second region form an electromagnetic band gap structure.

11. The antenna according to claim 10, wherein the reflection reducing component comprises:
a conductor unit array comprising a plurality of conductor units that are arranged in an array at substantially equal intervals with each other, each conductor unit comprising a capacitive element and an inductive element that are electrically connected to each other, such that an impedance of the conductor unit array within the first frequency band is higher than that of the first region of the reflector.

12-13. (canceled)

14. The antenna according to claim 11, wherein the conductor unit array comprises at least 5 conductor units in a lateral direction that is perpendicular to a longitudinal direction of the antenna.

15. The antenna according to claim 11, wherein the conductor unit array comprises a first sub-array and a second sub-array, and the first frequency band comprises a first sub-band and a second sub-band, and wherein
an impedance of the first sub-array within the first sub-band is higher than that of the first region of the reflector,
an impedance of the second sub-array within the second sub-band is higher than that of the first region of the reflector, and
the first sub-array and the second sub-array are adjacent in a lateral direction that is perpendicular to a longitudinal first direction of the antenna.

16-28. (canceled)

29. A multi-band antenna, comprising:
a reflector;
an array of first radiating elements that are configured to emit electromagnetic radiation within a first frequency band;
an array of second radiating elements that are configured to emit electromagnetic radiation within a second frequency band that is different from the first frequency band; and
a reflection reducing component positioned forwardly of the reflector that is configured to reduce a reflection of incident electromagnetic radiation that is within the first frequency band more than that of incident electromagnetic radiation that is within the second frequency band.

30. The antenna to claim 29, wherein the reflection reducing component is positioned on either side of the array of first radiating elements.

31. The antenna according to claim 29, wherein the reflection reducing component is not behind the array of first radiating elements.

32. The antenna according to any of claim 29, wherein the reflection reducing component comprises a plurality of conductor units that are arranged in an array, each conductor unit comprising a capacitive element and an inductive element that are electrically connected to each.

33. The antenna according to claim 32, wherein a first impedance of the array conductor units within the first frequency band is higher than a second impedance of the array conductor units within the second frequency band.

34. The antenna according to claim 32, wherein a first impedance of the array conductor units within the first frequency band is higher than a second impedance of a portion of the reflector that is not behind the reflection reducing component.

35. A multiband antenna, including:
a reflector;
an array of first radiating elements mounted to extend forwardly from the reflector and configured to emit electromagnetic radiation within a first frequency band;
an array of second radiating elements mounted to extend forwardly from the reflector and configured to emit electromagnetic radiation within a second frequency band different from the first frequency band; and
a reflection-reducing component, which is positioned in front of the reflector, wherein the reflection-reducing component includes a dielectric layer and a metallic pattern arranged on the first major surface of the dielectric layer; the metallic pattern includes periodically arranged pattern elements, wherein each pattern element includes a plurality of metallic sub-regions that are structurally separated from one another via slits; and
the reflection-reducing component is configured to reduce the reflection of the incident electromagnetic radiation within the first frequency band more than the reflection of the incident electromagnetic radiation within the second frequency band at a predetermined incident angle.

36. The multiband antenna according to claim 35, wherein each pattern element includes a plurality of metallic sub-regions that are structurally completely separated from one another via a plurality of slits.

37. The multiband antenna according to claim 35, wherein the metallic pattern comprises a plurality of pattern elements that are periodically arranged and are structurally separated from one another.

38. The multiband antenna according to claim 35, wherein the reflection-reducing component is implemented as a printed circuit board component, the printed circuit board component further comprises a ground layer arranged on the second major surface of the dielectric layer opposite to the first major surface, the metallic pattern is printed on the first major surface of the dielectric layer of the printed circuit board component, and the ground layer is formed as a copper clad layer printed on the second major surface of the dielectric layer.

39. The multiband antenna according to claim 38, wherein each pattern element forms a resonant cavity together with the corresponding dielectric layer and the ground layer and/or reflector, to at least partially absorb the incident electromagnetic radiation within the first frequency band.

40-71. (canceled)
